(19) United States
(12) Patent Application Publication
(10) Pub. No.: US 2007/0183395 A1
(43) Pub. Date: Aug. 9, 2007

(54) Enhanced home location register

(76) Inventors: Avneesh Balyan, Columbus, OH (US); Michael J. Rudolph, Naperville, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 11/348,027

(22) Filed: Feb. 6, 2006

(51) Int. Cl. H04L 12/66

(52) U.S. Cl. 370/352

(57) ABSTRACT

An apparatus in one example has: at least one circuit switching network; IMS network; and an enhanced home location register operatively coupled to each of the at least one circuit switching network and the IMS network, the enhanced home location register functioning as a home location register for the at least one circuit switching network, and functioning as HLR application server for the IMS network.

### TECHNICAL FIELD

The invention relates generally to telecommunication networks, and more particularly to a telecommunications network that provide synchronization of subscriber data when subscribers roam in a circuit based core network as well as in a IP Multi Media Sub-system (IMS) network.

### BACKGROUND

Wireless and wired communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Some available modulation schemes include digital modulation schemes using Time Division Multiple Access (TDMA) or Code Division Multiple Access (CDMA). Some phones are also capable of VoIP (Voice over Internet Protocol).

VoIP is a term used in IP telephony for a set of facilities for managing the delivery of voice information using the Internet Protocol. In general, this means sending voice information in digital form in discrete packets rather than in the traditional circuit-committed protocols of the public switched telephone network. In addition to IP, VoIP uses the real-time protocol to help ensure that packets get delivered in a timely way.

In a network, where subscribers are allowed to roam in a circuit based core network as well as an (IP based) IP Multi Media Sub-system (IMS) network, the synchronization of subscriber data becomes complex. The call model is different as well as the management of subscriber profile in these different networks.

In the circuit based core network (ANSI-41 and UMTS), Home Location Register (HLR) keeps the subscriber profile. HLR acts as the profile repository and execute the logic related to the profile related services. One example is updating the supplementary services subscriber profile by the subscriber from the handset. The subscriber can enter “#66#” (an example, the code can be specific to technology, country or operators) from User Equipment (UE) to initiate the “Call Forwarding Activation”. This “Feature Code” reaches the HLR network. The HLR updates the profile and stores the new value.

In an IP based IMS a network, SIP is used as the call session management protocol. HSS acts as the subscriber profile repository. In an IMS network, the concept of subscriber profile is different from the service related profile. HSS profile provides the information about the services provisioned by the operator for a subscriber and where these services need to be executed. These service execution nodes are known as Application Servers. Application Server keeps the profile required for the execution of the supported services. When, for example, the subscriber enters “#66#” (an example from earlier circuit mode network), the profile is changed at the Application Server. For the subscriber which roams in different core networks, IMS and Circuit network, the synchronization of this profile is “must have” feature.

Thus there is a need in the art for an improved system that provides synchronization of subscriber data when subscribers roam in a circuit based core network as well as in a IP Multi Media Sub-system (IMS) network.

### SUMMARY

One implementation encompasses an apparatus. This apparatus may comprise: at least one circuit switching network; IMS network; and an enhanced home location register operatively coupled to each of the at least one circuit switching network and the IMS network, the enhanced home location register functioning as a home location register for the at least one circuit switching network, and functioning as HLR application server for the IMS network.

One implementation encompasses a method. This embodiment of the method may comprise: using an enhanced home location register, which is operatively coupled to each of at least one circuit switching network and an IMS network, as a home location register for the at least one circuit switching network, and as a HLR application server for the IMS network; accepting, by the enhanced home location register as an HLR application server, a SIP request for a subscriber profile change and internally sending the SIP request to update the subscriber HLR profile for use in the circuit switching network; and accepting, by the enhanced home location register as an HLR application server, a update request for a subscriber profile change and updating the subscriber profile for use in a packet data network by the enhanced home location register acting as a SIP node for the profile change in the packet data network.

### DESCRIPTION OF THE DRAWINGS

Features of exemplary implementations will become apparent from the description, the claims, and the accompanying drawings in which:

FIG. 1 is a general diagram of the software architecture for an embodiment according to the present method and apparatus.

FIG. 2 shows the call flow of the scenario when subscriber is roaming in IMS network and changes its profile, for example, changing the call forwarding number.

FIG. 3 shows the call flow of the scenario when subscriber is roaming in UMTS/GSM network and changes its profile, for example, changing the call forwarding number.

FIG. 4 shows the call flow of the scenario when subscriber is roaming in ANSI-41 network and changes its profile, for example, changing the call forwarding number.

FIG. 5 depicts an embodiment of a telecommunication system according to the present method and apparatus.

### DETAILED DESCRIPTION

In an embodiment of the present method and apparatus a SDHLR (Super Distributed Home Location Register, also referred to an enhanced home location register) acts as an HLR in a circuit network and as an IMS Application Server (also referred to as an HLR application server) in IMS network. The SDHLR as an application server will accept a SIP request for a profile change and may internally send the request to update the subscriber profile for the circuit mode i.e. HLR profile. The routing of the IMS network may be provisioned to support this. The routing mechanism may first send the profile change request to the SDHLR acting as an application server for the profile change in the IMS network (as well as the HLR for the same subscriber in the circuit network). Once this request is successfully executed by the SDHLR application server, the profile change request may be sent to the Telecom Application Server (TAS). This routing may be achieved with a provisioning of multi-precedence IFC (Initial Filter Criteria) in the Home Subscriber Server (HSS), in the IMS network.

The following anachronisms are used herein:

Call Forwarding—Busy (CFB)

Call Forwarding—Default (CFD)

Call Forwarding—No Answer (CFNA)

Call Forwarding—Unconditional (CFU)

Call Transfer (CT)

Call Waiting (CW)

Calling Number Identification Presentation (CNIP)

Calling Number Identification Restriction (CNIR)

Conference Calling (CC)

Do Not Disturb (DND)

Flexible Alerting (FA)

Message Waiting Notification (MWN)

Mobile Access Hunting (MAH)

Password Call Acceptance (PCA)

Preferred Language (PL)

Priority Access and Channel Assignment (PACA)

Remote Feature Control (RFC)

Selective Call Acceptance (SCA)

Subscriber PIN Access (SPINA)

Subscriber PIN Intercept (SPINI)

Three-Way Calling (3WC)

Voice Message Retrieval (VMR)

Voice Privacy (VP)

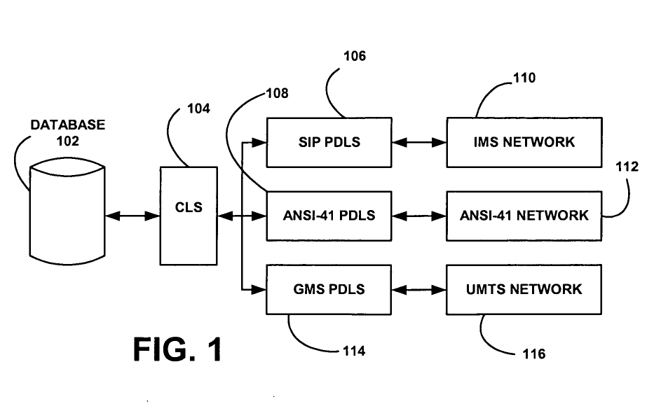

FIG. 1 is a general diagram of the software architecture for an embodiment according to the present method and apparatus. In this embodiment a SIP protocol dependent logic server (PDLS) 106 may be used to operatively couple an IMS network 110 to a common logic server (CLS) 104. An ANSI-41 PDLS 108 may be used to operatively couple an ANSI-41 network 112 to the CLS 104. A GMS PDLS 114 may be used to operatively couple a UMTS network 116 to the CLS 104. The CLS 104 may be operatively coupled to a database 102 that contains feature codes.

The IMS network may provide access to an IP multimedia subsystem. The HLR application server may store subscriber feature data from the home location register during transactions initiated on the IMS network. The HLR application server may also store subscriber feature data from the home location register during transactions initiated on the circuit switching network. Subscriber features may be stored in the home location register, and the subscriber features may comprise at least one of: CFB, CFD, CFNA, CFU, CW, CNIP CNIR, CC, DND, FA, MWN, MAH, PCA, P, PACA, RFC, SCA, SPINI, SPINA, TWC, VMR, and VP.

The subscriber features may be stored in the home location register, and the subscriber features may comprise at least one of: ringback tone information, incoming call screening information, and VPN. The HLR application server is identified in SIP calls for changing telephony subscriber feature calls.

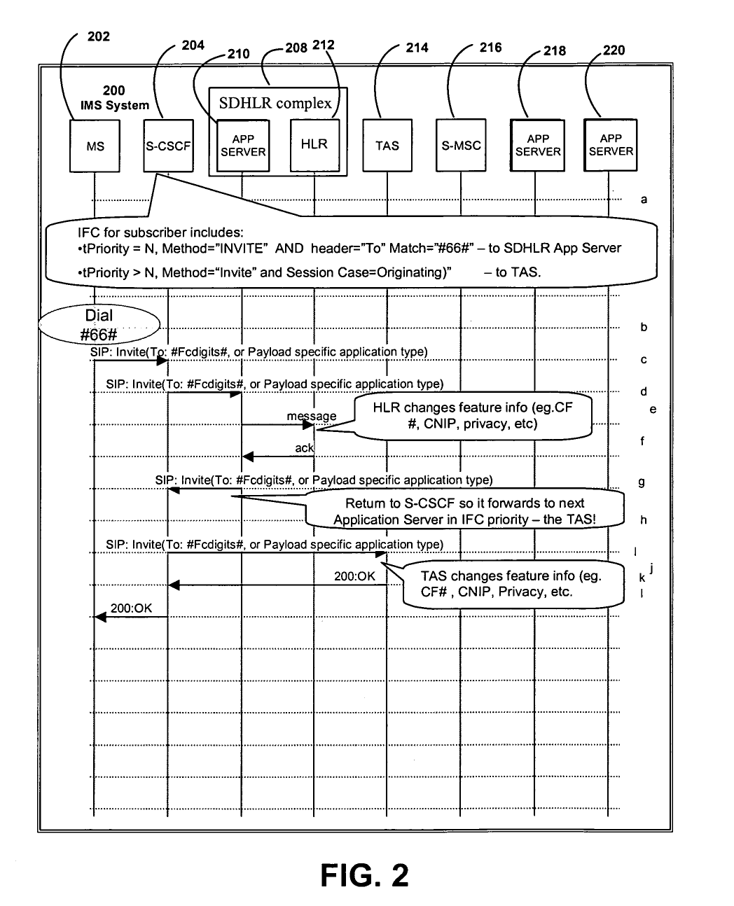

FIG. 2 is flowchart depicting an embodiment according to the present method. More specifically, FIG. 2 shows the call flow of the scenario when subscriber is roaming in IMS network and changes its profile, for example, a change in call forwarding number. This change is propagated to the subscriber's circuit network profile at SDHLR HLR functionality. This is done with SDHLR acting as application server for the profile change in the IMS network. This scenario will work for both UMTS/GSM and ANSI-41 scenario, as SDHLR has a capability to act as HLR for both GSM/UMTS and ANSI-41 subscribers.

In some of the following described methods, sometimes a SIP invite may be used, but since no session may be necessary for this SIP transaction, other SIP commands may be considered to be equivalent, for example, SIP message and SIP Info.

Furthermore, some of the following described methods use dialed feature strings. The dialed feature strings may be equivalently represented as keystroke sequences on the mobile terminal. For example, *72Grandmas# may be represented by Settings>Forwarding>Unconditional>On>Grandmas# as entered on the phone prompts. The equivalent information may be transported in a SIP message from either of the two dialing models.

FIG. 2 depicts the following components in an IMS system 200: subscriber user equipment, such as, mobile station (MS) 202; a serving call session control function (CSCF) 204; a super distributed home location register 208 having at least one application server (app server) 210 and at least one home location register (HLR) 212; a telephony application server (TAS) 214; a serving mobile switching center (S_MSC) 216; other application servers 218, 220. As depicted in FIG. 2 an embodiment of the present method may have the steps of:

a. The IFC for this subscriber includes forwarding INVITE with TO header containing the #66# string to the SDHLR app server. Additionally, but with lower precedence, the IFC indicates that the S-CSCF should forward INVITE messages that are mobile originations. These are configured to be sent to the Telephony Application Server. Other specific IFCs can be created. The IFCs allow access to both App servers (TAS and HLR AS).

b. #66# is dialed from the UE.

c. The SIP enabled UE sends SIP request with “TO” set to #66#, indicating that the subscriber wishes to activate the service.

d. The SIP Invite is forwarded (through the P-CSCF—not shown) to the S-CSCF. Assuming a current registration, with iFC as described in the above step, the S-CSCF identifies the origination as matching both the defined iFC. It will be sent to the SDHLR App Server, and after returning from that entity, to the TAS.

e. In this step we see the S-CSCF apply the highest precedence iFC and send the SIP Invite to the SDHLR App Server.

f. The HLR recognized a #66# string and changes data corresponding to the meaning of the feature assigned to #66#.

g. The success or failure is acknowledged.

h. To relay the call to the destination (or in this case to the next IFC in sequence) the SIP:INVITE is returned to the S-CSCF like it was received.

i. The S-CSCF receives the SIP invite, notices another IFC has not been routed, and routes the INVITE to the TAS.

j. TAS changes the feature info internally.

k. To relay the call to the destination (or in this case to the next IFC in sequence) the SIP:INVITE is returned to the S-CSCF like it was received.

l. The S-CSCF identifies no additional matching IFC and sends the SIP invite toward the destination.

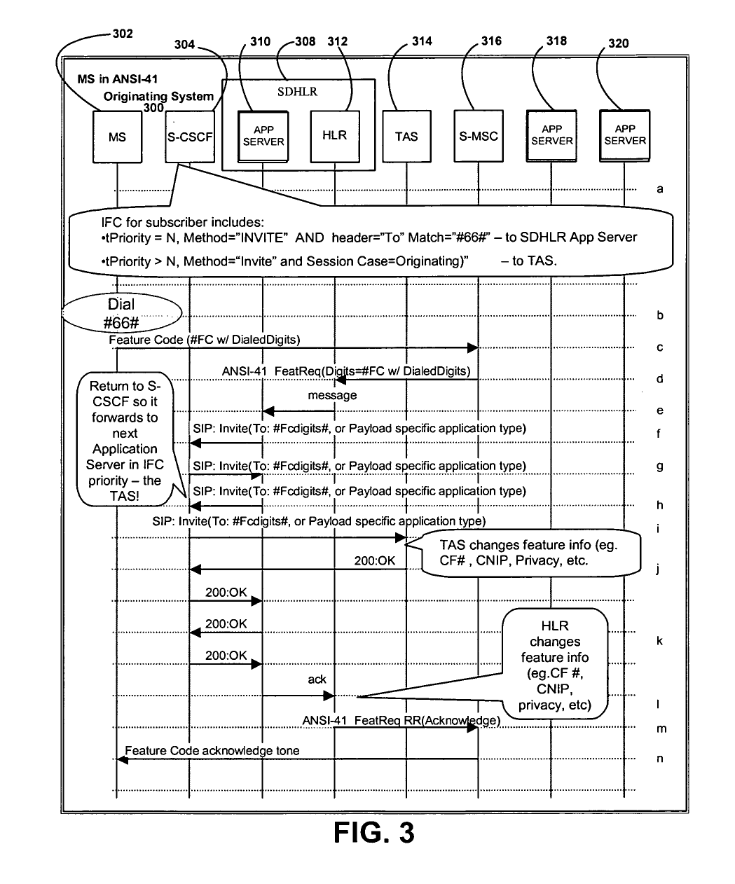

FIG. 3 is flowchart depicting an embodiment according to the present method. FIG. 3 shows the call flow of the scenario when subscriber is roaming in UMTS/GSM network and changes its profile, for example, a change in call forwarding number. This profile change will be done at SDHLR, means for those subscribers SDHLR is acting as HLR. This change is propagated to the subscriber's IMS profile. This is done with SDHLR acting as SIP node for the profile change in the IMS network.

FIG. 3 depicts the following components in an ANSI-41 system 300: subscriber user equipment, such as, mobile station (MS) 302; a serving call session control function (CSCF) 304; a super distributed home location register 308 having at least one application server (app server) 310 and at least one home location register (HLR) 312; a telephony application server (TAS) 314; a serving mobile switching center (S_MSC) 316; other application servers 318, 320. As depicted in FIG. 3 an embodiment of the present method may have the steps of:

a. The IFC for this subscriber includes forwarding INVITE with TO header containing the #66# string to the SDHLR app server. Additionally, but with lower precedence, the IFC indicates that the S-CSCF should forward INVITE messages that are mobile originations. These are configured to be sent to the Telephony Application Server.

b. #66# is dialed from the UE.

c. The ANSI-41 (CDMA) serving system receives dialed digits from the subscriber's mobile station (MS). The serving system detects a “#” character as the first dialed digit. This indicates that the dialed digits are a feature code string.

d. The serving system sends a FEATREQ message to the HLR, including the digits received from the subscriber.

e. The SDHLR recognizes a #66# string and sends the request to SDHLR IMS Application server CF for initiating the request for profile change in TAS (IMS network).

f. The SDHLR AS CF sends SIP request with “TO” set to #66#, indicating that the subscriber wishes to activate the service. The SIP Invite is forwarded to the S-CSCF. Assuming a current registration, with IFC as described in the above step, the S-CSCF identifies the origination as matching both the defined IFC. It will be sent to the SDHLR App Server, and after returning from that entity, to the TAS.

g. In this step we see the S-CSCF apply the highest precedence iFC and send the SIP Invite to the SDHLR App Server. The HLR recognizes a #66# string and from the request that this was initiated by SDHLR only, SDHLR will respond without updating the profile.

h. To relay the call to the destination (or in this case to the next IFC in sequence) the SIP:INVITE is returned to the S-CSCF like it was received.

i. The S-CSCF receives the SIP invite, notices another IFC has not been routed, and routes the INVITE to the TAS.

j. TAS changes the feature info internally.

k. The success or failure is acknowledged.

l. Upon the successful response at SDHLR AS CF (about the updating of profile at TAS), SDHLR will update the profile at HLR subscriber profile.

m. The HLR returns a featreq message to the serving system, indicating a successful feature control request.

n. The serving system sends a feature confirmation signal to the subscriber.

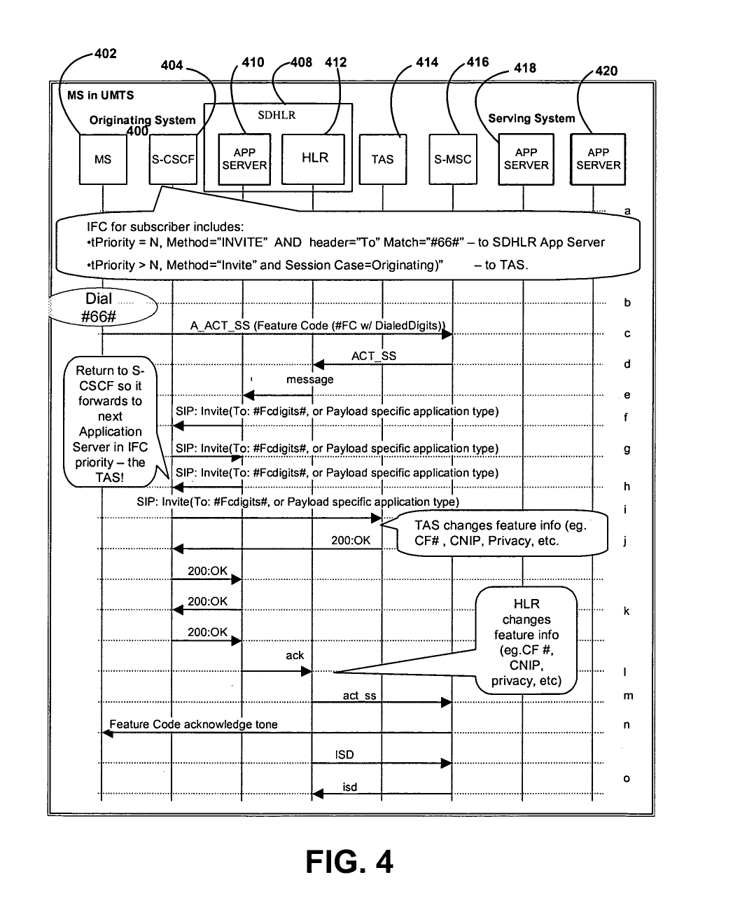

FIG. 4 is flowchart depicting an embodiment according to the present method. FIG. 4 shows the call flow of the scenario when subscriber is roaming in ANSI-41 network and changes its profile, for example, a change in call forwarding number. This profile change will be done at SDHLR, means for those subscribers SDHLR is acting as HLR. This change is propagated to the subscriber's IMS profile. This is done with SDHLR acting as SIP node for the profile change in the IMS network.

FIG. 4 depicts the following components in a UMTS system 400: subscriber user equipment, such as, mobile station (MS) 402; a serving call session control function (CSCF) 404; a super distributed home location register 408 having at least one application server (app server) 410 and at least one home location register (HLR) 412; a telephony application server (TAS) 414; a serving mobile switching center (S_MSC) 416; other application servers 418, 420. As depicted in FIG. 4 an embodiment of the present method may have the steps of:

a. The IFC for this subscriber includes forwarding INVITE with TO header containing the #66# string to the SDHLR app server. Additionally, but with lower precedence, the IFC indicates that the S-CSCF should forward INVITE messages that are mobile originations. These are configured to be sent to the Telephony Application Server.

b. #66# is dialed from the UE.

c. The GSM serving system receives an ACTIVATE_SS message from the subscriber's mobile station (MS), indicating that the subscriber wishes to activate the CFU service.

d. The serving system sends an ACTIVATE_SS message to the HLR (SDHLR UMTS CF), constructed based on the information received in the ACTIVATE_SS message.

e. The SDHLR recognizes a #66# string and sends the request to SDHLR IMS Application server CF for initiating the request for profile change in TAS (IMS network).

f. The SDHLR AS sends SIP request with “TO” set to #66#, indicating that the subscriber wishes to activate the service. The SIP Invite is forwarded to the S-CSCF. Assuming a current registration, with iFC as described in the above step, the S-CSCF identifies the origination as matching both the defined iFC. It will be sent to the SDHLR App Server, and after returning from that entity, to the TAS.

g. In this step we see the S-CSCF apply the highest precedence iFC and send the SIP Invite to the SDHLR App Server. The HLR recognizes a #66# string and from the request that this was initiated by SDHLR only, SDHLR will respond without updating the profile.

h. To relay the call to the destination (or in this case to the next IFC in sequence) the SIP:INVITE is returned to the S-CSCF like it was received.

i. The S-CSCF receives the SIP invite, notices another IFC has not been routed, and routes the INVITE to the TAS.

j. TAS changes the feature info internally.

k. The success or failure is acknowledged.

l. Upon the successful response at SDHLR AS CF (about the updating of profile at TAS), SDHLR will update the profile at HLR subscriber profile.

m. HLR returns an activate_ssconfirmation message to the serving system, indicating a successful feature control request.

n. The serving system sends an activation response message to the subscriber

o. Because the request resulted in a change to the subscriber's service profile, the HLR (SDHLR) reports the change by sending an Insert Subscriber Data message to the IIF emulating the Serving MSC/VLR. The Serving MSC (S-MSC) returns an Insert Subscriber Data Ack message to the HLR.

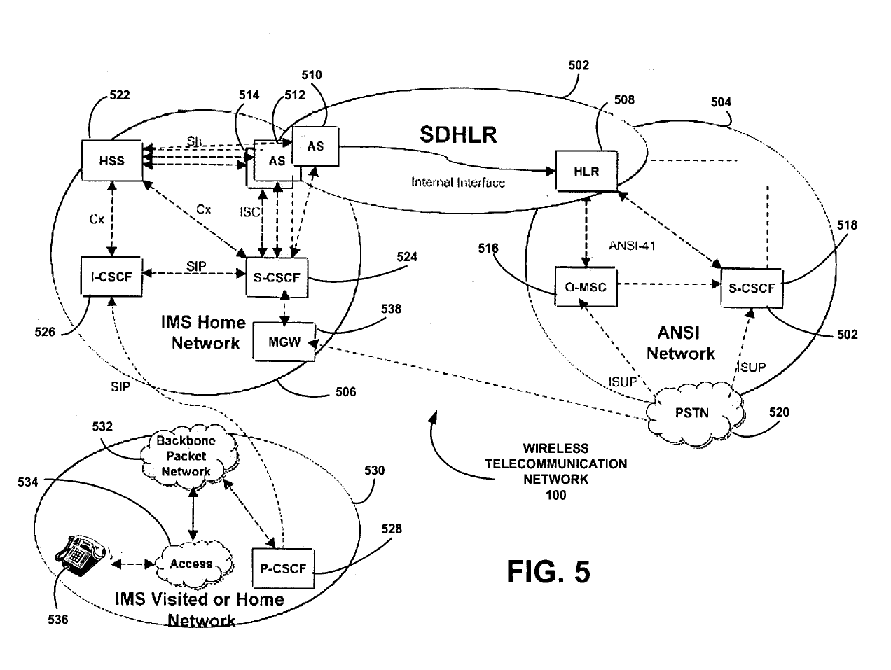

FIG. 5 depicts an embodiment of a telecommunication system 500 in which the methods depicted in FIGS. 2, 3 and 4 may be implemented. In this embodiment a SDHLR 502 is operatively coupled to an ANSI network 504 and to an IMS network 506. The SDHLR 502 may have an HLR 508 and a plurality of ASs 510, 512, 514. The HLR 508 may be operatively coupled to an O-MSC 516 and an S-CSCF 518. The O-MSC 516 and the S-CSCF 518 are also coupled to a public switched telephone network (PSTN) 520.

The ASs 510, 512, 514 may be also operatively coupled to an HSS 522 and an S-CSCF 524 in the IMS network 506. The HSS 522 and the S-CSCF 524 may be operatively coupled to one another, and also operatively coupled to an I-CSCF 526. The S-CSCF 524 may also be operatively coupled to a MGW 538 that couples the IMS network 506 to the PSTN 520. S-CSCF 524 A P-CSCF 528 in a further IMS network 530 may be operatively coupled to the I-CSCF in the IMS network 506. The P-CSCF 528 may be operatively coupled to a backbone packet network 532 that is turn is coupled to a telephone station 536 via an access 534.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. A system, comprising:
at least one circuit switching network;
IMS (IP multimedia subsystem) network; and
an enhanced home location register operatively coupled to each of the at least one circuit switching network and the IMS network, the enhanced home location register functioning as a home location register for the at least one circuit switching network, and functioning as HLR (home location register) application server for the IMS network.

2. The system according to claim 1, wherein the enhanced home location register has an internal interface that operatively couples the home location register to the HLR application server.

3. The system according to claim 2, wherein the internal interface is one of an ANSI-41 and a GSM MAP interface.

4. The system according to claim 1, wherein the HLR application server stores subscriber feature data from the home location register during transactions initiated on the IMS network.

5. The system according to claim 1, wherein the HLR application server stores subscriber feature data from the home location register during transactions initiated on the circuit switching network.

6. The system according to claim 1, wherein subscriber features are stored in the home location register, and wherein the subscriber features comprise at least one of: Call Forwarding—Busy (CFB), Call Forwarding—Default (CFD), Call Forwarding—No Answer (CFNA), Call Forwarding—Unconditional (CFU), Call Transfer (CT), Call Waiting (CW), Calling Number Identification Presentation (CNIP), Calling Number Identification Restriction (CNIR), Conference Calling (CC), Do Not Disturb (DND), Flexible Alerting (FA), Message Waiting Notification (MWN), Mobile Access Hunting (MAH), Password Call Acceptance (PCA), Preferred Language (PL), Priority Access and Channel Assignment (PACA), Remote Feature Control (RFC), Selective Call Acceptance (SCA), Subscriber PIN Access (SPINA), Subscriber PIN Intercept (SPINI), Three-Way Calling (3WC), Voice Message Retrieval (VMR), and Voice Privacy (VP).

7. The system according to claim 1, wherein subscriber features are stored in the home location register, and wherein the subscriber features comprise at least one of: ringback tone information, incoming call screening information, and VPN.

8. The system according to claim 1, wherein the HLR application server is identified in SIP calls for changing telephony subscriber feature calls.

9. A method, comprising:
using an enhanced home location register, which is operatively coupled to each of at least one circuit switching network and an IMS network, as a home location register for the at least one circuit switching network, and as a HLR application server for the IMS network;
accepting, by the enhanced home location register as an HLR application server, a SIP request for a subscriber profile change and internally sending the SIP request to update the subscriber HLR profile for use in the circuit switching network; and
accepting, by the enhanced home location register as an HLR application server, a update request for a subscriber profile change and updating the subscriber profile for use in a packet data network by the enhanced home location register acting as a SIP node for the profile change in the packet data network.

10. The method according to claim 9, wherein the HLR application server is identified in SIP calls for changing telephony subscriber feature calls.

11. The method according to claim 10, wherein the HLR application server interacts as an IMS application server, for at least one of retrieval, modification, and validation of HLR specific data.

12. The method according to claim 10, wherein success/failure of a transaction at the HLR application server is conveyed to additional application servers in the IMS network.

13. The method according to claim 12, wherein the HLR application server interprets the success/failure and synchronizes equivalent local data.

14. A method, comprising:
providing an IFC for a subscriber that forwards an SIP request containing a predetermined string to an application server in an enhanced home location register;
generating the predetermined string from SIP enabled user equipment of the subscriber;
sending the SIP request from the user equipment indicating that the subscriber desires to activate service;
forwarding the SIP invite to a serving CSCF, identifying by the serving CSCF an origination of the SIP request via the IFC;
sending the SIP request to an HLR application server in the enhanced home location register;
recognizing the predetermined string by a home location register in the enhanced home location register, and changing data corresponding to a feature assigned to predetermined string;
returning an acknowledgment of success or failure from the home location register to the application server;
relaying the call to a next IFC in sequence, if a next IFC exists, by returning the SIP request to the serving CSCF like it was received;
determining, by the serving CSCF, that another IFC has not been routed, and routing the SIP request to a Telephony application server;
changing feature information internally by the Telephony application server;
returning the SIP request to the serving CSCF like it was received in order to relay the call to the destination or to a next IFC in the sequence, if a next IFC exists; and
sending the SIP invite to the destination when the serving CSCF identifies no additional matching IFC.

15. The method according to 14 wherein, the HLR information remains unchanged until it receives acknowledgement that the Telephony application server was successful.

16. The method according to claim 15, wherein the system comprises a plurality of circuit switching networks, and wherein the enhanced home location register is coupled to each of the circuit switching networks and functions as a home location register for each of the circuit switching networks.

17. A method, comprising:
providing an IFC for a subscriber that forwards an SIP request containing a predetermined string to an application server in an enhanced home location register;
entering the required feature information from SIP enabled user equipment of the subscriber;
sending the request from the user equipment indicating that the subscriber desires to activate service;
receiving dialed digits from the user equipment by a circuit switching serving system, detecting a predetermined character in the predetermined string that indicates that the dialed digits are a feature code string;
sending, by the serving system, a predetermined message to a home location register in the enhanced home location register that includes digits received from the subscriber;
recognizing, by the enhanced home location register, a predetermined string of the dialed digits, and sending an internal request to an IMS application server in the enhanced home location register for initiating a request for profile change in a packet data network;
sending a SIP request containing the predetermined string, indicating that the subscriber wishes to activate the service, from the application server in the enhanced home location register to a serving CSCF;
recognizing the predetermined string by a home location register in the enhanced home location register, and from the request that this was initiated by the enhanced home location register only, the enhanced home location register responding without updating the profile;
returning the SIP request to the serving CSCF like it was received in order to relay the call to the destination or to a next IFC in the sequence, if a next IFC exists;
receiving, by the serving CSCF, the SIP request and routing the SIP request to a Telephony application server;
changing internally, by the Telephony application server, feature information;
acknowledging success or failure of changes to feature information to the serving CSCF;
monitoring the success of the Telephony application server change,
updating, upon a successful acknowledgement, a profile of the subscriber at the home location register in the enhanced home location register;
returning, by the home location register, a predetermined message to the serving system indicating a successful feature control request; and
sending, by the serving system, a feature confirmation signal to the user equipment of the subscriber.

18. The method according to claim 17, wherein the system comprises a plurality of circuit switching networks, and wherein the enhanced home location register is coupled to each of the circuit switching networks and functions as a home location register for each of the circuit switching networks.

19. A method according to claim 18, wherein MS to S-MSC messaging and S-MSC and HLR messaging employs standard CDMA2000 air interface and ANSI operations, respectively.

20. A method, comprising:
providing an IFC for a subscriber that forwards an SIP request containing a predetermined string to an application server in an enhanced home location register;
dialing the predetermined string from SIP enabled user equipment of the subscriber;
receiving by a circuit switching serving system a predetermined message from user equipment of a subscriber indicating that the subscriber desires to activate a feature service;
sending, by the serving system, a further message to a home location register;
recognizing, by the enhanced home location register, a predetermined string of the dialed digits, and sending an internal request to an IMS application server in the enhanced home location register for initiating a request for profile change in a packet data network;
sending a SIP request containing the predetermined string, indicating that the subscriber wishes to activate the service, from the application server in the enhanced home location register to a serving CSCF;
recognizing the predetermined string by a home location register in the enhanced home location register, and from the request that this was initiated by the enhanced home location register only, the enhanced home location register responding without updating the profile;
returning the SIP request to the serving CSCF like it was received in order to relay the call to the destination or to a next IFC in the sequence, if a next IFC exists;
receiving, by the serving CSCF, the SIP request and routing the SIP request to a HLR application server if there is another IFC that has not yet been routed;
monitoring the success of the Telephony application server change;
changing internally, by the HLR application server, feature information;
acknowledging success or failure of changes to feature information to the serving CSCF;
updating, upon a successful acknowledgement, a profile of the subscriber at the home location register in the enhanced home location register;
returning, by the home location register, a predetermined message to the serving system indicating a successful feature control request; and
sending, by the serving system, a feature confirmation signal to the user equipment of the subscriber.

21. The method according to claim 20, wherein the system comprises a plurality of circuit switching networks, and wherein the enhanced home location register is coupled to each of the circuit switching networks and functions as a home location register for each of the circuit switching networks.

22. The method according to claim 20, wherein MS to S-MSC messaging and S-MSC and HLR messaging employs standard GSM air interface and GSM MAP operations, respectively.

23. A method, comprising:
in a first part:
providing an IFC for a subscriber that forwards an SIP request containing a predetermined string to an application server in an enhanced home location register;
generating the predetermined string from SIP enabled user equipment of the subscriber;
sending the SIP request from the user equipment indicating that the subscriber desires to activate service;
forwarding the SIP invite to a serving CSCF, identifying by the serving CSCF an origination of the SIP request via the IFC;
sending the SIP request to an HLR application server in the enhanced home location register;
recognizing the predetermined string by a home location register in the enhanced home location register, and changing data corresponding to a feature assigned to predetermined string;
returning an acknowledgment of success or failure from the home location register to the application server;
relaying the call to a next IFC in sequence, if a next IFC exists, by returning the SIP request to the serving CSCF like it was received;
determining, by the serving CSCF, that another IFC has not been routed, and routing the SIP request to a Telephony application server;
changing feature information internally by the Telephony application server;
returning the SIP request to the serving CSCF like it was received in order to relay the call to the destination or to a next IFC in the sequence, if a next IFC exists; and
sending the SIP invite to the destination when the serving CSCF identifies no additional matching IFC;
in a second part:
providing an IFC for a subscriber that forwards an SIP request containing a predetermined string to an application server in an enhanced home location register;
entering the required feature information from SIP enabled user equipment of the subscriber;
sending the request from the user equipment indicating that the subscriber desires to activate service;
receiving dialed digits from the user equipment by a circuit switching serving system, detecting a predetermined character in the predetermined string that indicates that the dialed digits are a feature code string;
sending, by the serving system, a predetermined message to a home location register in the enhanced home location register that includes digits received from the subscriber;
recognizing, by the enhanced home location register, a predetermined string of the dialed digits, and sending an internal request to an IMS application server in the enhanced home location register for initiating a request for profile change in a packet data network;
sending a SIP request containing the predetermined string, indicating that the subscriber wishes to activate the service, from the application server in the enhanced home location register to a serving CSCF;
recognizing the predetermined string by a home location register in the enhanced home location register, and from the request that this was initiated by the enhanced home location register only, the enhanced home location register responding without updating the profile;
returning the SIP request to the serving CSCF like it was received in order to relay the call to the destination or to a next IFC in the sequence, if a next IFC exists;
receiving, by the serving CSCF, the SIP request and routing the SIP request to a Telephony application server;
changing internally, by the Telephony application server, feature information;
acknowledging success or failure of changes to feature information to the serving CSCF;
monitoring the success of the Telephony application server change,
updating, upon a successful acknowledgement, a profile of the subscriber at the home location register in the enhanced home location register;
returning, by the home location register, a predetermined message to the serving system indicating a successful feature control request; and
sending, by the serving system, a feature confirmation signal to the user equipment of the subscriber.

24. The method according to claim 23, wherein feature modification is allowed and communicated to both the HLR and TAS, encompassed by user initiation while the mobile terminal responds in one of circuit networks and packet networks.
